(19) United States
(12) Patent Application Publication
(10) Pub. No.: US 2013/0141442 A1
(43) Pub. Date: Jun. 6, 2013

(54) METHOD AND APPARATUS FOR MULTI-CHIP PROCESSING

(71) Applicants: John W. Brothers, Sunnyvale, CA (US); Greg Sadowski, Cambridge, MA (US); Konstantine Iourcha, San Jose, CA (US); Bryan Black, Spicewood, TX (US)

(72) Inventors: John W. Brothers, Sunnyvale, CA (US); Greg Sadowski, Cambridge, MA (US); Konstantine Iourcha, San Jose, CA (US); Bryan Black, Spicewood, TX (US)

(21) Appl. No.: 13/311,908

(22) Filed: Dec. 6, 2011

(51) Int. Cl. G06F 15/16

(52) U.S. Cl. 345/502

(57) ABSTRACT

Various methods, computer-readable mediums and apparatus are disclosed. In one aspect, a method of generating a graphical image on a display device is provided that includes splitting geometry level processing of the image between plural processors coupled to an interposer. Primitives are created using each of the plural processors. Any primitives not needed to render the image are discarded. The image is rasterized using each of the plural processors. A portion of the image is rendered using one of the plural processors and any remaining portion of the image using one or more of the other plural processors.

### BACKGROUND OF THE INVENTION

1. Field of the Invention

This invention relates generally to semiconductor processing, and more particularly to multi-chip systems and methods of making and using the same.

2. Description of the Related Art

Various multi-chip system designs have been created over the past few years. One such conventional design utilizes one or more semiconductor chips stacked on an interposer. The interposer includes a central opening to facilitate the placement of one or more small footprint semiconductor chips. Wire bonds and solder bumps are typically used to interconnect the chips to the interposer.

One conventional multi-chip system that does not use an interposer is the AMD CrossFireX™ system. The AMD CrossfireX™ system typically consists of two discrete graphics cards and selected drivers and algorithms that enable the graphics processing units (GPU) of each card to act in concert to render graphics images. In a typical conventional system, the discrete graphics cards interface with a system board by way of PCI express slots and the PCI express bus. The PCI express bus is rarely if ever dedicated to the conveyance of graphics traffic only. A typical pipeline for rendering a graphics image includes the sensing and generation of control points (typically by the central processing unit and graphics generating software, e.g. a video game), a tesselation stage, the creation of primitives (typically, though not exclusively, triangles), rasterization, pixel level processing and the actual rendering by shaders. The control points, tesselation and primitive creation steps all constitute so-called “geometry level” processing. The latter stages constitute pixel level processing. The AMD CrossfireX™ is able to use multiple GPUs in order to do the pixel processing component of the GPU pipeline just described. However, the AMD CrossfireX™ system: (1) may exhibit excessive latency when rendering in alternate frame rendering (AFR) mode and using more than two GPU's; (2) will not scale linearly in performance if rendering in single frame rendering (SFR) mode; and (3) does not permit one GPU to directly access memory associated with another GPU. Even for pixel level processing, communication between the discrete GPU's may be bandwidth limited due to the requirement for the PCI express bus to carry other than purely graphics traffic.

The present invention is directed to overcoming or reducing the effects of one or more of the foregoing disadvantages.

### SUMMARY OF EMBODIMENTS OF THE INVENTION

In accordance with one aspect of an embodiment of the present invention, a method of generating a graphical image on a display device is provided that includes splitting geometry level processing of the image between plural processors coupled to an interposer. Primitives are created using each of the plural processors. Any primitives not needed to render the image are discarded. The image is rasterized using each of the plural processors. A portion of the image is rendered using one of the plural processors and any remaining portion of the image using one or more of the other plural processors.

In accordance with another aspect of an embodiment of the present invention, computer readable medium is provided that has computer-executable instructions for performing a method that includes splitting geometry level processing of the image between plural processors coupled to an interposer. Primitives are created using each of the plural processors. Any primitives not needed to render the image are discarded. The image is rasterized using each of the plural processors. A portion of the image is rendered using one of the plural processors and any remaining portion of the image using one or more of the other plural processors.

In accordance with another aspect of an embodiment of the present invention, an apparatus is provided that includes a substrate, a first processor coupled to the substrate, a first memory device associated with the first processor, a second processor coupled to the substrate and a second memory device associated with the second processor. The first and second processors are operable to distribute a local frame buffer across the first and second memory devices.

In accordance with another aspect of an embodiment of the present invention, an apparatus is provided that includes a substrate, plural processors coupled to the substrate, and a computer readable medium. The computer readable medium has computer-executable instructions for splitting geometry level processing of the image between at least the first and second processors, creating primitives using each of the plural processors, discarding any primitives not needed to render the image, rasterizing the image using each of the plural processors, and rendering a portion of the image using one of the plural processors and any remaining portion of the image using one or more of the other plural processors.

### BRIEF DESCRIPTION OF THE DRAWINGS

The foregoing and other advantages of the invention will become apparent upon reading the following detailed description and upon reference to the drawings in which:

FIG. 1 is a pictorial view of an exemplary embodiment of a semiconductor chip device 10 that may include plural modules mounted on a substrate;

FIG. 2 is an overhead view of the exemplary device of FIG. 1;

FIG. 3 is a sectional view of FIG. 2 taken at section 3-3;

FIG. 4 is a portion of FIG. 3 shown at greater magnification;

FIG. 5 is a block diagram of an exemplary embodiment of a bridge chip;

FIG. 6 is a pictorial view of an alternate exemplary embodiment of a semiconductor chip device that may include multiple modules on an interposer;

FIG. 7 is a partially exploded pictorial view of an exemplary semiconductor chip device and a carrier substrate;

FIG. 8 is a pictorial view of the exemplary semiconductor chip device exploded from another electronic device;

FIG. 9 is a schematic view of an exemplary display device and primitives handling for an exemplary object; and

FIG. 10 is a flowchart of an exemplary distributed graphics processing methodology.

### DETAILED DESCRIPTION OF SPECIFIC EMBODIMENTS

Various multi-chip systems and methods of distributing the computing load between modules of these systems are disclosed. In one embodiment, two modules, each consisting of a GPU and some additional external memory, are mounted on a semiconductor interposer. Local frame buffer functionality is distributed across the memory devices for each of the modules. In addition, geometry level processing is first distributed across each of the GPU's. Pixel level processing follows to enable the GPU's to alternately write primitives to assigned particular tiles. Additional details will now be described.

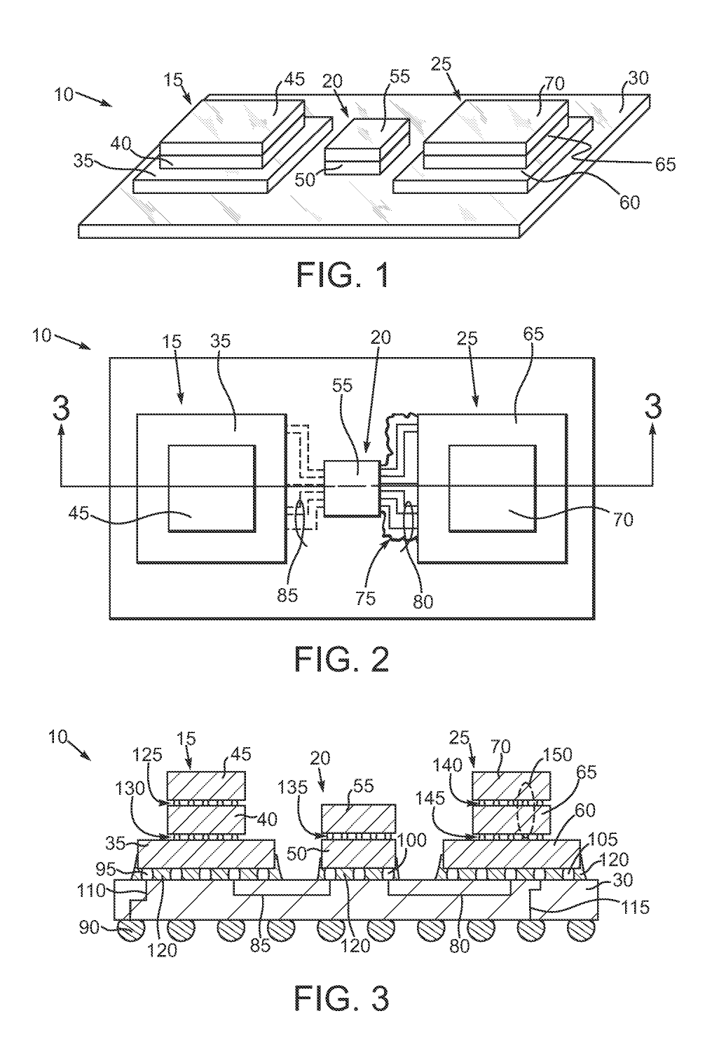

In the drawings described below, reference numerals are generally repeated where identical elements appear in more than one figure. Turning now to the drawings, and in particular to FIG. 1, therein is shown a pictorial view of an exemplary embodiment of a semiconductor chip device 10 that may include plural modules 15, 20 and 25 mounted on a substrate 30. As described more fully below, the number and configuration of the modules 15, 20 and 25 may be subject to great variety. In this illustrative embodiment, the module 15 may consist of stacked semiconductor chips 35, 40 and 45, the module 20 may consist of stacked semiconductor chips 50 and 55, and the module 25 may consist of stacked semiconductor chips 60, 65 and 70. The semiconductor chips 35, 40, 45, 50, 55, 60, 65 and 70 may be used to implement a great variety of different types of logic devices, such as, for example, microprocessors, graphics processors, combined microprocessor/graphics processors, application specific integrated circuits, memory devices or the like, and may be single or multi-core or even stacked with additional dice. In this illustrative embodiment, the semiconductor chip 50 may be configured as a bridge chip that provides various services to enable the modules 15 and 25 to communicate with one another and with the individual chips 35, 40, 45, 60, 65 and 75 thereof. Some exemplary functions of the bridge chip 50 will be described in conjunction with subsequent figures below. The semiconductor chips 35, 40, 45, 50, 55, 60, 65 and 70 may be constructed of a variety of materials, such as bulk semiconductor in the form of, for example, silicon, germanium or graphene, or semiconductor on insulator materials, such as silicon-on-insulator materials.

The substrate 30 may be an interposer or other circuit board. If configured as an interposer, the substrate 30 may consist of a substrate of material(s) with a coefficient of thermal expansion (CTE) that is near the CTE of the semiconductor chips 35, 40, 45, 50, 55, 60, 65 and 70 and that includes plural internal conductor traces and vias (not visible in FIG. 1) for electrical routing. Various semiconductor materials may be used, such as silicon, germanium or the like. Silicon has the advantage of a favorable CTE and the widespread availability of mature fabrication processes. Of course, the substrate 30 could also be fabricated as an integrated circuit like the other semiconductor chips 35, 40, 45, 50, 55, 60, 65 and 70. In either case, the interposer substrate 30 could be fabricated on a wafer level or chip level process. Indeed, the semiconductor chips 35, 40, 45, 50, 55, 60, 65 and 70 could be fabricated on either a wafer or chip level basis, and then singulated and mounted to the substrate 30 that has not been singulated from a wafer. Singulation of the substrate 30 would follow mounting of the modules 15, 20 and 25.

If configured as a circuit board, the substrate 30 may take on a variety of configurations. Examples include a semiconductor chip package substrate, a circuit card, or virtually any other type of printed circuit board. Although a monolithic structure could be used for the substrate 30 as a circuit board, a more typical configuration will utilize a buildup design. In this regard, the substrate 30 may consist of a central core of polymer materials upon which one or more buildup layers of polymer materials are formed and below which an additional one or more buildup layers of polymer materials are formed. The core itself may consist of a stack of one or more layers. If implemented as a semiconductor chip package substrate, the number of layers in the circuit board 15 can vary from four to sixteen or more, although less than four may be used. So-called “coreless” designs may be used as well. The layers of the circuit board 15 may consist of an insulating material, such as various well-known epoxies, interspersed with metal interconnects. A multi-layer configuration other than buildup could be used. Optionally, the substrate 30 as a circuit board may be composed of well-known ceramics or other materials suitable for package substrates or other printed circuit boards.

Additional details of the semiconductor chip device 10 may be understood by referring now also to FIG. 2, which is a plan view. Note that the semiconductor chips 35 and 45 of the module 15, the semiconductor chip 55 of the module 20 and the semiconductor chips 60 and 70 of the module 25 are visible. The semiconductor chip device 10 is designed to accommodate a huge volume of data and other signals traffic between the modules 15, 20 and 25. To accommodate this high volume of signals traffic, the substrate 30 is provided with very wide interconnects. These interconnects may be configured as metal traces formed in or on the substrate 30. Note that a portion of the substrate 30 is shown cut away at 75 to reveal a few of these interconnect traces 80 between the module 20 and the module 25. A corresponding plurality of traces 85 that provide interconnect between the module 15 and the module 20 are embedded and thus shown in phantom. It should be understood that, particularly where the substrate 30 is configured as an interposer, the number of interconnects 80 and 85 may be in the scores, hundreds or even thousands.

Additional details of the semiconductor chip device 10 may be understood by referring now to FIG. 3, which is a sectional view of FIG. 2 taken at section 3-3. The substrate 30 may be provided with plural interconnect structures to facilitate the electrical connection of the semiconductor chip device 10 to some other device such as a circuit board or other interposer or some other device. Here, the interconnect structures consist of a ball grid array of solder balls 90. Though is should be understood that the type of interconnect used to electrically interface the substrate 30 with some other device may consist of other types of interconnect structures such as pin grid arrays, land grid arrays, wire bonding or other types of interconnects. The semiconductor chip 35 of the module 15 may be electrically connected to the substrate 30 by way of plural interconnect structures 95, which may be solder joints, conductive pillar plus solder or other types of interconnect structures. The semiconductor chip 50 of the module 20 may be similarly electrically connected to the substrate 30 by way of plural interconnect structures 100, which may be like the interconnect structures 95 just described. Furthermore, the semiconductor chip 60 of the module 25 may be similarly electrically interfaced with the substrate 30 by way of interconnect structures 105, which may be like the interface structures 95 just described. The substrate 30 may be provided with multiple internal conductor structures such as thru-silicon vias (TSV), multiple layer metallization structures connected by vias or other types of routing structures to interface the modules with the interconnect structures 90. The term “TSV” as used herein applies to thru-vias in silicon and other substrate materials. For example, one such interconnect structure 110 is depicted connecting the semiconductor chip 35 to one of the solder balls 90 and another exemplary interconnect structure 115 is shown electrically connecting another of the solder balls 90 with one of the interconnect structures 105 for the semiconductor chip 60. The skilled artisan will appreciate that there may be scores, hundreds or thousands of such conductive pathways provided for the substrate 30. Indeed, two of the conductive traces 80 and 85 that link the modules 20 and 25 and 15 and 20, respectively, are shown in FIG. 3. Again, while the traces 80 and 85 are depicted as single continuous lines, the skilled artisan will appreciate that these interfaces may consist of plural layers of metallization interconnected by vias or other structures or may even be surface patterned conductive traces. To lessen the effects of differences in strain rate associated with different coefficients of thermal expansion, an underfill material 120 may be placed between the semiconductor chips 35, 50 and 60 and the substrate 30. The underfill material 120 may be composed of well-known epoxy materials, such as epoxy resin with or without silica fillers and phenol resins or the like. Two examples are types 119 and 2BD available from Namics.

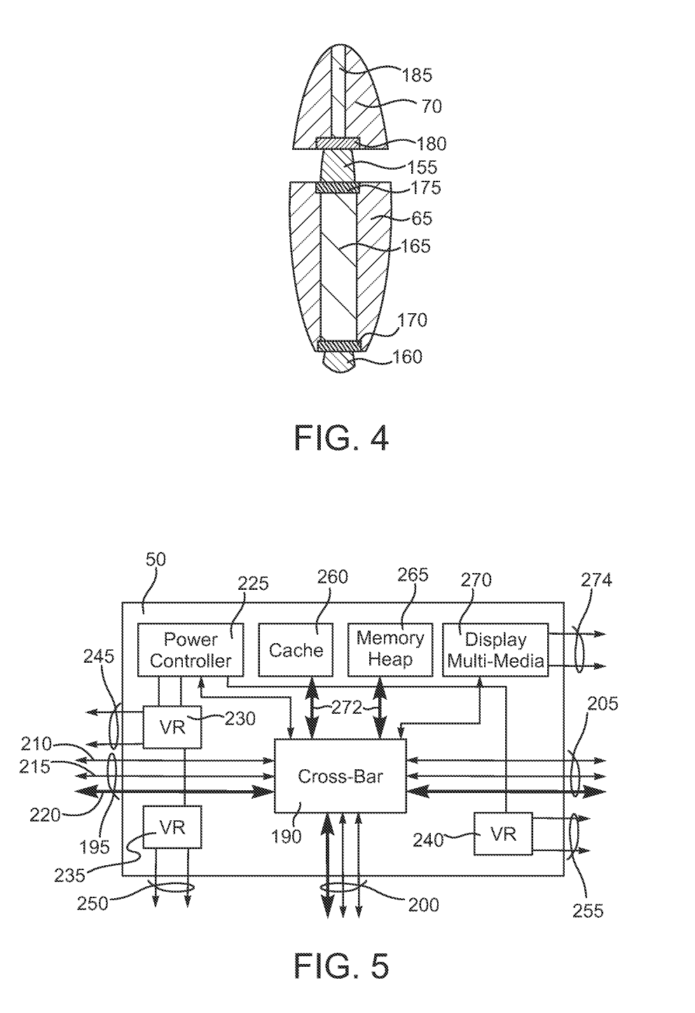

The semiconductor chips of a given module may be interconnected to one another in a variety of ways. For example, the semiconductor chips 40 and 45 are interconnected at 125 by interconnect structures and the semiconductor chip 40 is interconnected with the semiconductor chip 35 at 130 by interconnect structures. Similarly, the semiconductor chips 50 and 55 are interconnected at 135 by interconnect structures and the semiconductor chips 65 and 70 are interconnected at 140 by interconnect structures. Finally, the semiconductor chip 60 and 65 may be interconnected at 145 by interconnect structures. Additional details of some exemplary chip to chip interconnect structures such as those for interconnecting the chips 65 and 70 may be understood by referring now to FIG. 4, which is the portion of FIG. 3 circumscribed by the dashed oval 150 shown at greater magnification. It should be understood that the following description of the interconnect structures interconnecting the semiconductor chips 65 and 70 may be illustrative of any of the other chip-to-chip interconnect structures described herein. Due to the location of the dashed oval 150 in FIG. 3, FIG. 4 shows a small portion of the semiconductor chip 70, and a small portion of the semiconductor chip 65. The semiconductor chip 65 and 70 may be interconnected electrically by way of an interconnect structure 155, which may be a solder microbump, a bump plus conductive pillar or other interconnect structure. The semiconductor chip 65 may be similarly interconnected to the semiconductor chip 60 (see FIG. 3) by way of another interconnect structure 160, a portion of which is visible in FIG. 4. To facilitate the thru-chip electrical pathways necessary for chip to chip communication, the semiconductor chip 65 may be provided with a TSV 165 or other interconnect structures such as multiple patterned metallization layers interconnected by vias, etc. Assuming for the purposes of this illustration that the TSV 165 is used as the interface, then the conductive pads 170 and 175 may electrically connect the TSV 170 to the interconnect structures 160 and 155 respectively. Similarly, the semiconductor chip 70 may be provided with a conductor pad 180 that is electrically connected to the interconnect structure 155. An exemplary conductive pathway 185 is connected to the conductor pad 180. The pathway 185 may be a TSV, a conductor line or virtually any other type of interconnect structure. As just noted, the usage of pads, TSVs and conductive lines as well as solder joints or other interconnect structures typified by FIG. 4 may be used for chip to chip electrical interfaces elsewhere in the semiconductor chip device 10 depicted in FIGS. 1, 2 and 3. If solder is selected as a material for the interconnect structures 155 and 160, then various types of solder may be used such as various lead-free solders, although lead-based solders could be used. An exemplary lead-based solder may have a composition at or near eutectic proportions, such as about 63% Sn and 37% Pb. Lead-free examples include tin-copper (about 99% Sn 1% Cu), tin-silver (about 97.3% Sn 2.7% Ag), tin-silver-copper (about 96.5% Sn 3% Ag 0.5% Cu) or the like. Any of the conducting structures, such as the pads 170 and 175, thru silicon via 165, etc. may be composed of various types of conductor materials, such as, for example, copper, aluminum, silver, gold, titanium, refractory metals, refractory metal compounds, alloys of these or the like. In lieu of a unitary structure, the conductors may consist of a laminate of plural metal layers. However, the skilled artisan will appreciate that a great variety of conducting materials may be used for the conductors. Various well-known techniques for applying metallic materials may be used, such as physical vapor deposition, chemical vapor deposition, plating or the like. It should be understood that additional conductor structures could be used.

As noted briefly above in conjunction with FIGS. 1, 2 and 3, the semiconductor chip 50 may be implemented as a bridge chip that facilitates the efficient transmission of signals, data and even power between the modules 15, 20 and 25. If implemented as a bridge chip, the semiconductor chip 50 may take on a great variety of configurations. One exemplary embodiment of the semiconductor chip 50 is depicted in block diagram form in FIG. 5. The semiconductor chip 50 may include a cross-bar or switch 190 that may be implemented as, for example, a full 4×4 cross-bar switch. Since the semiconductor chip 50 is intended to receive all inter-module interface signals and re-route traffic to the appropriate module(s), e.g. to modules 15 or 25 shown in FIGS. 1, 2 and 3, the cross-bar 190 may have multiple sets 195, 200 and 205 of inputs/outputs (I/Os). The following description of the I/O set 195 is illustrative of the other I/O sets 200 and 205. The I/O set 195 may include I/Os 210 and 215 to carry control and address information and an I/O 220, depicted with heavier line weight, to carry higher bandwidth information, such as data. Read operations will typically, though not necessarily, be directed to a single module 15 or 25. Write operations might be directed to a single or multiple modules 15 and 25.

Power control inside of the semiconductor chip 50 may be provided by a power controller 225 that is connected to voltage regulators 230, 235 and 240. The power controller 225 may communicate with the remainder of the semiconductor chip device 10 (see FIGS. 1, 2 and 3) by way of I/O sets 245, 250 and 255. The chip 50 may also include a cache 260, which may be implemented as a L3 cache or other type of cache device. In addition, the chip 50 may include a memory heap 265 and a display multimedia block 270 capable of controlling the display of multimedia, each connected to the cross-bar 190 by data buses 272. The cache 260 may be used to minimize inter-module traffic, to act as a shared memory for commonly used data and synchronization and to reduce latency. For example, if the semiconductor chips 45 and 70 (see FIG. 3) are implemented as memory chips, and requests are made of those memory chips 45 and 70 by, for example, the semiconductor chips 60 and 35 respectively, then such memory requests can be first looked up in the cache 260 (indeed such look ups could simply be an address range) so that in the event that other processors had already accessed certain data, that data would be available in the cache 260 immediately. The memory heap 265 may consist of one or more memory devices in chip or on chip as desired. For example, the memory heap 265 may consist of the semiconductor chip 50 implemented as a memory device. Whether on or off chip, the memory heap 265 may include address mapping to the overall system memory of the semiconductor chip device 10 (see FIG. 3). It should be understood that memory addressable by any of the semiconductor 60 and 35 can be external to the substrate 30 (see FIG. 3) if desired.

The display multimedia block 270 is designed to simplify a static screen power state in which all other circuits could be powered off and a display image stored in the local memory heap 265. For example, during a period of inactivity in which there is no significant competing activity in the semiconductor chip device 10, the same screen may be displayed using the image stored in the memory heap 265 but with the ability to power down the display driver circuitry and software at that point. In addition, the display multimedia block 270 can provide a low power, self sufficient video playback and other video functions, such as video encoding, which can utilize the local memory heap 265 for storage purposes and in most cases would not require the resources of the remainder of the semiconductor chip device 10, which could otherwise be powered off. To interface with other components, such as display devices (not shown), the display multimedia block 270 may include an I/O set 274.

In an exemplary embodiment of the semiconductor chip device 10, the semiconductor chips 35 and 60 are implemented as GPUs, or with a GPU functionality, and one or more of the semiconductor chips 40, 45, 65 and 70 are implemented as memory devices and those memory devices are able to serve as local frame buffers for graphics processing. Each of the semiconductor chips includes a local memory controller. In conventional systems, a local frame buffer is dedicated to a particular processor. However in this illustrative embodiment, a local frame buffer functionality may be distributed across the semiconductor chip stacks 40, 45 and 65, 70. The distribution of local frame buffer functionality may be implemented by way of operating system code or other code as desired. By distributing the local frame buffer across the memory devices of the individual modules 15 and 25, redundant copies of data that might otherwise be resident in multiple buffers may be eliminated. This can free up memory storage. Part of the capability to distribute the local frame buffer functionality may be facilitated by the aforementioned bridge chip 50. It should be understood that only the cross bar 190 need be included in the bridge chip 50. In fact, an even more simplistic system without a bridge chip 50 but involving the usage of local memory controllers in each of the chips 30 and 60 could be used with appropriate code in order to facilitate the module to module communication.

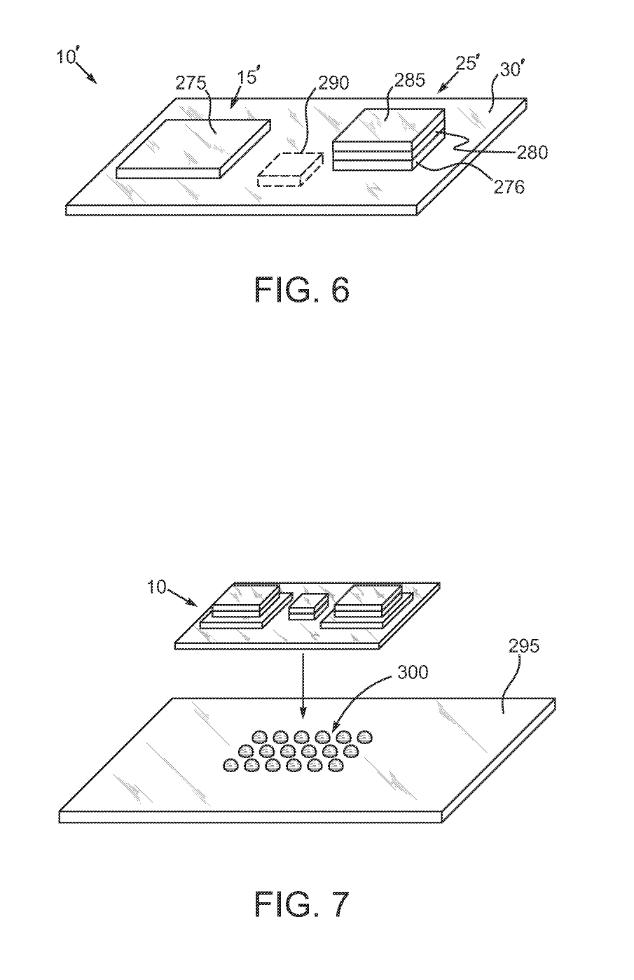

As noted above, the semiconductor chip device 10 may be implemented in a large variety of different configurations as well as the modules thereof. For example, FIG. 6 depicts a pictorial view of an alternate exemplary embodiment of a semiconductor chip device 10′ that utilizes modules 15′ and 25′. Here, the module 15′ consists of a single semiconductor chip and the module 25′ consists of a stack of three semiconductor chips 275, 280 and 285. The modules 15′ and 25′ may be mounted on a substrate 30′, which may be similar in design and function to the substrate 30 described elsewhere herein, with an important caveat. Here, the substrate 30′ may incorporate directly the logic associated with the semiconductor chip 50 described elsewhere herein. This logic is embedded within the substrate 30′ and represented by the dashed box 290.

As noted elsewhere herein, any of the disclosed embodiments of a semiconductor chip device, may be mounted to another device. In this regard, attention is now turned to FIG. 7, which is an exploded pictorial view showing the semiconductor chip device 10 exploded from a circuit board 295. The circuit board 295 may be a semiconductor chip, composed of ceramics, resin build up layers or other types of materials. Optionally, the circuit board 295 may be a circuit card, a motherboard or some other type of electronic circuit board. The semiconductor chip device 10 may be, in essence, flip chip mounted to the circuit board 295 by way of solder joints consisting of plural solder lands 300 and a corresponding plurality of solder structures on the semiconductor chip that are not visible.

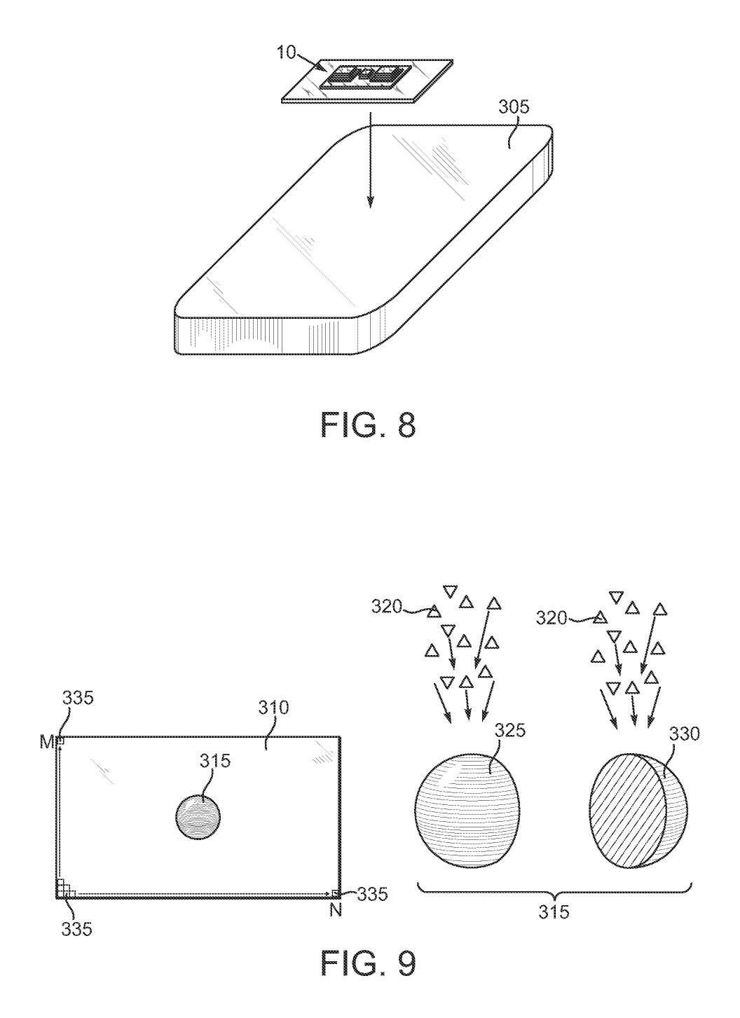

The combination of the semiconductor chip device 10 and the circuit board 295 may, in turn, be mounted to an electronic device 305 as shown in FIG. 8. The electronic device 305 may be a computer, a digital television, a handheld mobile device, a personal computer, a server, a memory device, an add-in board such as a graphics card, or any other computing device employing semiconductors.

A goal of the disclosed embodiments of the semiconductor chip devices 10, 10′, etc. is the efficient processing of graphics using multiple modules. Assume for the purposes of this illustration that the semiconductor chips 35 and 60 of the modules 15 and 25, respectively, are implemented as graphics processors and the remainder of the semiconductor chips 40, 45, 65 and 70 are implemented as random access memory devices. Examples of graphics processing for this exemplary arrangement include alternate frame rendering and single frame rendering. Alternate frame rendering may be suitable for systems that include two modules, such as the modules 15 and 25 depicted in FIGS. 1, 2 and 3. In systems that include more than two modules that include graphics processors, single frame rendering may be more appropriate. SFR can be implemented in several ways. In an exemplary embodiment, a round-robin distribution of geometry processing to all GPU modules 15 and 25 is used. A simple graphics rendering using this distributed graphics processing scheme may be understood by referring now to FIG. 9. FIG. 9 depicts a display device 310, which may be a discrete display like a monitor or an integrated display. Assume that the semiconductor chip device 10 (FIGS. 1, 2 and 3) is tasked to render a sphere 315 on the display 310. Each GPU module 15 and 25 independently processes geometry of the sphere 315 by way of primitives 320. A hardware-based, software-based or combined tesselator (not shown) may be utilized. Here, triangle primitives 320 are depicted, but the skilled artisan will appreciate that any type of primitive may be used, such as polygons, lines, spheres or others. The independent geometry processing continues to the point that only potentially visible primitives 320, such as those making up the visible half 325 of the sphere 315 are kept and those primitives 320 that represent the non-visible half 330 of the sphere 315 are clipped and back-face culled/trivially rejected. The retained primitives 320 associated with the sphere half 325 are then re-distributed to other GPU's according to what part of the display space they intersect. For example, the display 310 could be subdivided into N×M tiles 335 and the GPU modules 15 and 25 assigned to render specific tiles 335. Larger tiles 335 would reduce the inter-module geometry traffic, albeit at the cost of a more imbalanced distribution of rasterization load. An additional redistribution point might optionally be implemented above the tesselator to reduce traffic due to many small primitives resulting from patches (i.e., higher order surfaces) largely intersecting just one tile 335. In all cases, a GPU 35 in one module 15 (FIGS. 1, 2 and 3) can access memory in the other GPU module 25 via the wide interconnects 80 and 85 (FIGS. 2 and 3) and vice versa. Since memories can be separate logical devices and/or separate physical devices, this mutual memory access may involve addressing separate logical devices and/or physical devices. Note that this geometry processing load sharing may be used to render any type of image. It should be understood that where multiple modules are used to drive the display 310, alternating tiles may be rendered by a given processor.

The system is designed to advantageously load balance the tasks of rendering graphics images between two or more processors. For example, a typical pipeline for rendering a graphics image includes the sensing and generation of control points (typically by a CPU and graphics generating software, e.g. a video game), a tesselation stage, the creation of primitives (typically, though not exclusively, triangles), rasterization, pixel level processing and the actual rendering by shaders. The control points, tesselation and primitive creation steps all constitute so-called “geometry level” processing. As noted in the Background section above the AMD CrossfireX™ system can use multiple GPU's. However, the AMD CrossfireX™ system: (1) may exhibit excessive latency when rendering in alternate frame rendering (AFR) mode and using more than two GPU's; (2) will not scale linearly in performance if rendering in single frame rendering (SFR) mode; and (3) does not permit one GPU to directly access memory associated with another GPU.

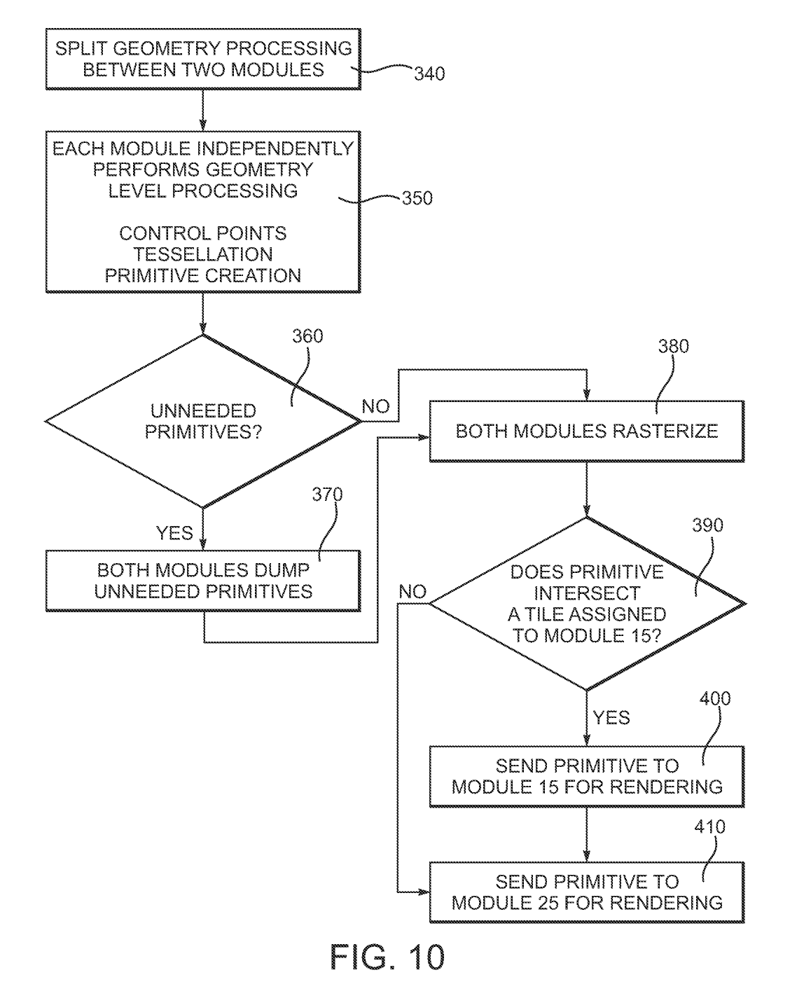

An exemplary method for balancing the geometry level processing using two processors will now be described in conjunction with FIG. 1 and the flowchart depicted in FIG. 10. At step 340, each module 15 and 25 shown in FIG. 1 splits geometry level processing. In other words, and at step 350, both modules 15 and 25 will perform control points, tesselation stage and primitive creation. The splitting of geometry level processing duties will typically be based on the division of tiles of the display between the two modules. This split may be along a vertical axis, a horizontal axis or virtually any other demarcation line. At step 360 the presence of any unneeded primitives is determined. If there are unneeded primitives then both modules 15 and 25 will dump unneeded primitives at step 370 and as generally described in conjunction with FIG. 9. Following any necessary primitives dump, both modules rasterize at step 380. The actual rendering of primitives will be based on what tiles are actually intersected by a given primitive. Thus, at step 390 it is determined whether a given primitive intersects a tile assigned to, for example, module 15. If yes, then the primitive is sent to module 15 for rendering at step 400. If not, then the primitive is sent to the other module, namely module 25, for rendering 370 at step 410.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of generating a graphical image on a display device, comprising:
splitting geometry level processing of the image between plural processors coupled to an interposer; and
rendering a portion of the image using one of the plural processors and any remaining portion of the image using one or more of the other plural processors.

2. The method of claim 1, comprising creating primitives using each of the plural processors, discarding any primitives not needed to render the portion and any remaining portion of the image, and rasterizing the image using each of the plural processors.

3. The method of claim 1, wherein the interposer comprises a semiconductor substrate.

4. The method of claim 1, wherein the plural processors include respective memory devices, the plural processors being operable to distribute a local frame buffer across the first and second memory devices.

5. The method of claim 1, comprising using a switch to facilitate communication between the plural processors.

6. The method of claim 5, wherein the switch comprises a crossbar.

7. A computer readable medium having computer-executable instructions for performing a method comprising:
splitting geometry level processing of the image between plural processors coupled to an interposer;
creating primitives using each of the plural processors;
discarding any primitives not needed to render the image;
rasterizing the image using each of the plural processors; and
rendering a portion of the image using one of the plural processors and any remaining portion of the image using one or more of the other plural processors.

8. The computer readable medium of claim 8, wherein the interposer comprises a semiconductor substrate.

9. An apparatus, comprising:
a substrate;
a first processor and a second processor coupled to the substrate;
a first memory device and a second memory device coupled to the substrate; and
wherein the first and second processors are operable to distribute a local frame buffer across the first and second memory devices.

10. The apparatus of claim 9, wherein the first and second memory devices comprise separate physical devices.

11. The apparatus of claim 9, wherein the first and second memory devices comprise separate logical devices.

12. The apparatus of claim 9, wherein the substrate comprises an interposer or a circuit board.

13. The apparatus of claim 9, wherein the first memory device comprises a first semiconductor chip stacked with the first processor and the second memory device comprises a second semiconductor chip stacked with the second processor.

14. The apparatus of claim 9, comprising a semiconductor switch coupled to the substrate and electrically coupled to the first and second processors to facilitate communication between the first and second processors.

15. The apparatus of claim 14, wherein the semiconductor switch comprises a crossbar.

16. An apparatus, comprising:
a substrate;
plural processors coupled to the substrate; and
a computer readable medium having computer-executable instructions for splitting geometry level processing of the image between at least the first and second processors, creating primitives using each of the plural processors, discarding any primitives not needed to render the image, rasterizing the image using each of the plural processors, and rendering a portion of the image using one of the plural processors and any remaining portion of the image using one or more of the other plural processors.

17. The apparatus of claim 16, wherein the substrate comprises an interposer or a circuit board.

18. The apparatus of claim 16, wherein the interposer comprises a semiconductor substrate.

19. The apparatus of claim 16, comprising a semiconductor switch coupled to the substrate and electrically coupled to the first and second processors to facilitate communication between the first and second processors.

20. The apparatus of claim 16, wherein the plural processors include respective memory devices, the plural processors being operable to distribute a local frame buffer across the first and second memory devices.

21. The apparatus of claim 16, wherein at least some of the primitives comprise triangles.

22. The apparatus of claim 16, wherein the computer readable medium comprises a floppy disk, a hard disk, an optical disk, a flash memory, a ROM or a RAM.
